(19) United States
(12) Patent Application Publication
(10) Pub. No.: US 2018/0283915 A1
(43) Pub. Date: Oct. 4, 2018

(54) LIQUID LEVEL DETECTING APPARATUS AND METHOD

(71) Applicant: Wanghui HUANG, (US)

(72) Inventor: Wanghui HUANG, (US)

(21) Appl. No.: 15/524,923

(22) PCT Filed: Feb. 20, 2017
(86) PCT No.: PCT/CN2017/074165

§ 371 Date: May 5, 2017

(30) Foreign Application Priority Data
Dec. 9, 2016 (CN) 201611130594.3

(51) Int. Cl. G01F 1/56; G01F 22/00; G01F 23/24

(52) U.S. Cl. CPC G01F 1/56; G01F 23/24; G01F 22/00

(57) ABSTRACT

A liquid level detecting apparatus comprises: a container (10), a partition plate (110), a first electrode pair (120), a second electrode pair (130), and a master chip (210). The partition plate (110) dividing the container (10) into a first containing chamber (101) and a second containing chamber (103). The master chip (210) is electrically coupled to the first electrode pair (120) and the second electrode pair (130), respectively, which is configured to measure a first voltage value Uf of the first electrode pair (120) and a second voltage value Ux of the second electrode pair (130) and calculates a height Hx of the conductive liquid of the second containing chamber (103).

### FIELD OF THE INVENTION

The present disclosure relates to the field of liquid level detecting technology, and more particularly relates to a liquid level detecting apparatus and a method.

### BACKGROUND OF THE INVENTION

A conventional liquid detecting technology includes the following: firstly, a scale measuring method, secondly, a flowmeter measuring method, thirdly, a built-in float measuring method, fourthly, a capacitive induction measuring method.

In this case, the scale measuring method refers to that a graduation scale is etched on the container to measure the liquid lever. When a height of the liquid level in the container is to be measured, the height of the liquid level in the container can be read directly through the scale. However, the method requires to etching the graduation scale on the container in advance, therefore it is inconvenient to use and cannot be applied to controlling he level liquid intelligently.

The flowmeter measuring method refers to installing the flowmeter in the container and measuring the liquid volume of the container by discharging the liquid and calculating the height of the liquid level according to the cross-sectional area of the container. However, the process of the method is complex and cannot obtain the liquid level directly, and it has high cost and low practical value.

The built-in float method that calculating the height of the liquid level by installing the float in the container and being combined with a lever or a sensor switch. when the float follows the liquid level to reach a specific position, the relevant device will show a signal variation to measure the height of the liquid level. However the method can measure a single point of the liquid level height and cannot do continuous measuring of a plurality of points.

The capacitive sensing method that installing a capacitive sensor control panel on the container shell and taking advantage of the characteristics that when the height of the liquid level varies, a capacitive value of the container varies at the same time to measure the height of the liquid level. The measuring accuracy of installing the capacitive sensor control panel outside the container is poor and can only measure a single point of the liquid level height and cannot do a continuous measuring of a plurality of points.

### SUMMARY

Therefore, it is necessary to provide a liquid level detecting apparatus and method having high measuring accuracy and being capable of achieving multi-point continuous measuring of a liquid height.

A liquid level detecting apparatus includes a container configured to contain conductive liquid; a partition plate dividing the container into a first containing chamber and a second containing chamber, the first containing chamber is located on a bottom of the container, and the second containing chamber is located on a top of the container; the first containing chamber is full of the conductive liquid, and the second holding chamber is partially filled with the conductive liquid; a first electrode pair is vertically arranged in the first containing chamber and in contact with the bottom of the container and extended to the partition plate; a second electrode pair vertically is arranged in the second containing chamber and abuts against the partition plate and extends along an extension direction of the first electrode pair and extended to the top of the container, the second electrode pair is electrically coupled to the first electrode pair; a master chip is electrically coupled to the first electrode pair and the second electrode pair, respectively; the master chip is configured to measure a first voltage value Uf of the first electrode pair and a second voltage value Ux of the second electrode pair and calculates a height Hx of the conductive liquid in the second containing chamber according to a following equation: Hx=Hf×Uf/Ux, and Hf represents the height from the partition plate to the bottom of the container.

Further, a liquid level detecting method based on the liquid level detecting apparatus is also provided, the method comprises:

injecting the conductive liquid, the first containing chamber is full of the conductive liquid, and the second holding chamber is partially filled with the conductive liquid;

obtaining a height Hf of the conductive liquid of the first containing chamber;

collecting a first voltage value of the first electrode pair and a second voltage value of the second electrode pair;

calculating a height Hx of the conductive liquid of the second containing chamber according to a following equation:

Hx=Hf×Uf/Ux

Hf represents the height from the partition plate to the bottom of the container.

The foregoing liquid level detecting apparatus and the method can calculate the height of the conductive liquid in the second containing chamber by obtaining the height from the partition plate to the bottom of the container. The arbitrary height of the conductive liquid in the second containing chamber can be calculated according to the foregoing liquid level detecting apparatus, which has a low cost, a high measuring accuracy and a high efficiency.

### BRIEF DESCRIPTION OF THE DRAWINGS

To illustrate the technical solutions according to the embodiments of the present disclosure or in the prior art more clearly, the accompanying drawings for describing the embodiments or the prior art are introduced briefly in the following. The accompanying drawings in the following description are only some embodiments of the present invention, and persons of ordinary skill in the art can derive other obvious variations from the accompanying drawings without creative efforts.

FIG. 1 is a model diagram of calculating internal resistance of conductive solid;

FIG. 2 is a model diagram of calculating internal resistance of conductive liquid;

FIG. 3 is a schematic diagram of a liquid level detecting apparatus according to an embodiment;

FIG. 4 is a schematic diagram of a liquid level detecting apparatus according to another embodiment;

FIG. 5 is an equivalent principle diagram of the liquid level detecting device of FIG. 3;

FIG. 6 is a controlling principle diagram of a master chip according to an embodiment;

FIG. 7 is an equivalent principle diagram of the liquid level detecting device according to another embodiment;

FIG. 8 is an equivalent principle diagram of a cylindrical liquid level detecting device according to an embodiment;

FIG. 9 is an equivalent principle diagram of the cylindrical liquid level detecting device according to another embodiment;

FIG. 10 is a flowchart of a liquid level detecting method according to an embodiment; and

FIG. 11 is a flowchart of the liquid level detecting method according to another embodiment.

### DETAILED DESCRIPTION OF THE EMBODIMENTS

The accompanying drawings according to the embodiments of the present disclosure will be described in the following to illustrate the technical solutions according to the embodiments of the present disclosure more clearly and completely. The described implementations are merely specific embodiments of the present disclosure, and any implementations derived from the foregoing implementations without creative efforts by persons skilled in the art shall all fall within the protection scope of the present disclosure.

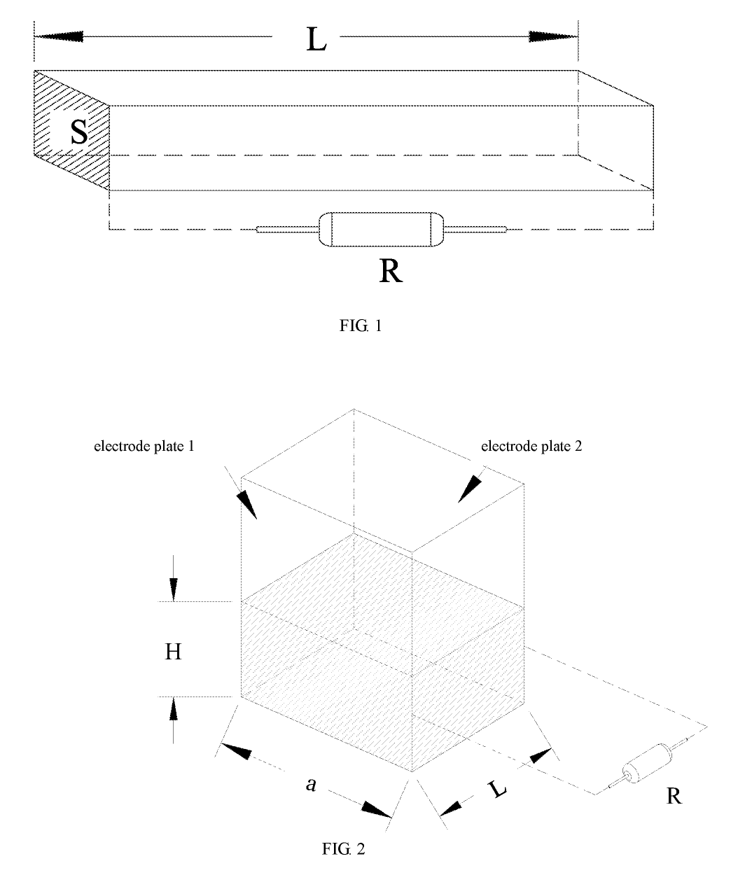

Referring to FIG. 1, an equation of calculating internal resistance is as follows: R=ρL/S, where p represents internal resistance of a conductor, S represents a cross-sectional area of the conductor, and L represents a length of the conductor.

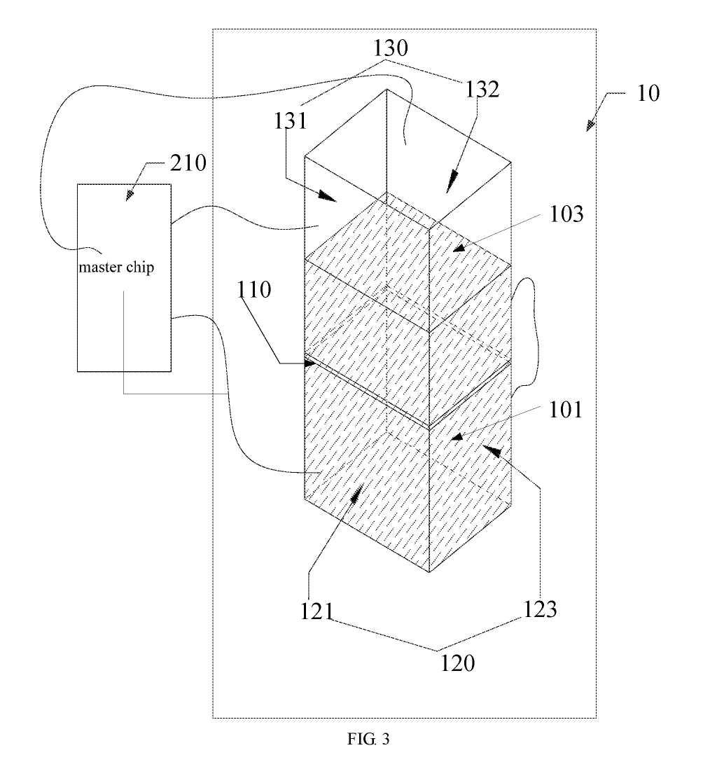

Referring to FIG. 2, an electrode plate 1 and an electrode plate 2 are provided on the opposing inner walls of an container, respectively, and conductive liquid is injected into the container. Thus internal resistance R of the conductive liquid between the electrode plate 1 and the electrode plate 2 can be expressed as:

R=ρ×L/S Eq. (1-1)

In the equation, ρ represents liquid internal resistance, L represents an interval between the electrode plate 1 and the electrode plate 2, and S represents an cross-sectional area of the conductive liquid. The cross-sectional area of the conductive liquid S=a×H; a represents a width of the electrode plate, and H represents a height of the conductive liquid. The equation of the cross-sectional area of the conductive liquid is taken into Equation 1-1 to calculate the height H of the conductive liquid. The height H of the conductive liquid can be expressed as:

H=ρL/(a×R) Eq. (1-2)

In one embodiment, referring to FIG. 3, a liquid level detecting apparatus includes a container 10, a partition plate 110, a first electrode pair 120, a second electrode pair 130, and a master chip 210. The container 10 is used to contain the conductive liquid. The partition plate 110 divides the container into a first containing chamber 101 and a second containing chamber 103, which are vertically arranged. The first containing chamber 101 is located on a bottom of the container 10, and the second containing chamber 103 is located on a top of the container 10. A liquid level line of the conductive liquid is located in the second containing chamber 103, i.e., the conductive liquid can fully fill the first containing chamber 101, a portion of the conductive liquid is contained in the second containing chamber 103. The first containing chamber 101 is referred as a reference containing chamber.

The first electrode pair 120 is vertically arranged in the first containing chamber 101 and is in contact with the bottom of the container 10 and extends to the partition plate 110. The second electrode pair 130 is vertically arranged in the second containing chamber 103 and abuts against the partition plate 110. The second electrode pair 130 extends along an extension direction of the first electrode pair 120 and extends to the top of the container 10. The second electrode pair 130 is electrically coupled to the first electrode pair 120.

The master chip 210 is electrically coupled to the first electrode pair 120 and the second electrode pair 130, respectively. The master chip 210 is used to measure a first voltage value Uf of the first electrode pair 120 and a second voltage value Ux of the second electrode pair 130 and calculates a height Hx of the conductive liquid in the second containing chamber according to the following equation: Hx=Hf×Uf/Ux. The height Hf of the conductive liquid in the first containing chamber 101 represents the height from the partition plate 110 to the bottom of the container 10. The height Hx of the conductive liquid in the second containing chamber 103 represents the height from the liquid level to the partition plate 110. The height Hx can be calculated by acquiring the height Hf.

The arbitrary height of the conductive liquid in the second containing chamber 103 can be calculated by the foregoing liquid level detecting apparatus, which has low cost, high measuring accuracy, and high efficiency.

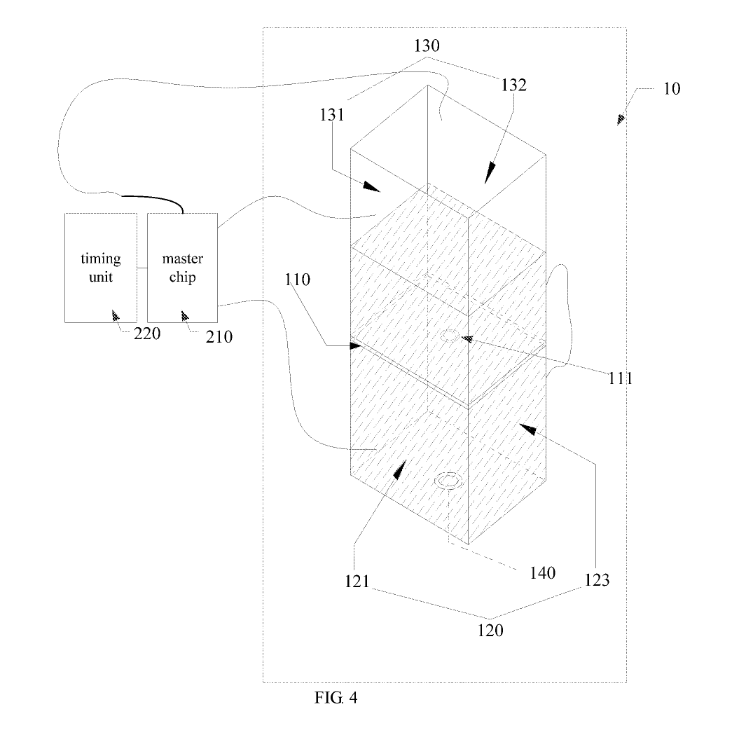

In one embodiment, referring to FIG. 4, the container defines an outlet 140 on a bottom thereof an outlet, and the conductive liquid flows out through the outlet 140 to vary the liquid level. A liquid guiding means 111 is provided in the container 10, which can direct the conductive liquid in the second containing chamber 103 to the first containing chamber 101 and fill the first containing chamber 101. The first containing chamber 101 is referred as the reference containing chamber.

In one embodiment, the liquid level detecting apparatus further includes a timing unit 220. The timing unit 220 is used to record a length of time before and after continuous variation of the height of the conductive liquid in the second containing chamber 103. The master chip 210 is further used to calculate flow rate at the outlet 140 according to a bottom area of the container which is in contact with the conductive liquid, a height difference before and after continuous variation of the conductive liquid in the second containing chamber 103, and the length of time.

The flow rate at the outlet 140 can be calculated by the foregoing liquid level detecting apparatus for an arbitrary period of time, which has low cost, high measuring accuracy and high efficiency.

In one embodiment, the first electrode pair 120 includes a first electrode plate 121 and a second electrode plate 123, and the heights of the first electrode plate 121 and the second electrode plate 123 are the same. The second electrode pair 130 includes a third electrode plate 131 and a fourth electrode plate 133, and the heights of the third electrode plate 131 and the fourth electrode plate 133 are the same. The third electrode plate 131 extends along an extending direction of the first electrode plate 121, and the fourth electrode plate 133 extends along an extending direction of the second electrode plate 123.

The first electrode plate 121 has a similar or same structure as that of the third electrode plate 131, and the second electrode plate 123 has a similar or same structure as that of the fourth electrode plate 133. Perhaps, the structure of the first electrode plate 121, the second electrode plate 123, the third electrode plate 131 and the fourth electrode plate 133 are the similar or same.

In one embodiment, the container 10 is shaped as a cuboid. The first electrode plate 121, the second electrode plate 123, the third electrode plate 131, and the fourth electrode plate 133 are shaped as rectangles. The first electrode plate 121 is attached to a first inner wall of the container 10, and the second electrode plate 123 is in parallel to the first electrode plate 121 and is attached to a second inner wall arranged opposite to the first inner wall. The third electrode plate 131 is attached to the first inner wall and extends along an extending direction of the first electrode plate 121; and the fourth electrode plate 133 is attached to the second inner wall of the second containing chamber 103 and extends along an extending direction of the second electrode plate 123.

In one embodiment, the first electrode plate 121 completely covers the first inner wall of the first containing chamber 101, and the second electrode plate 123 completely covers the second inner wall of the first containing chamber 101. The third electrode plate 131 completely covers the second inner wall of the second containing chamber 103, and the fourth electrode plate 133 completely covers the second inner wall of the second containing chamber 103.

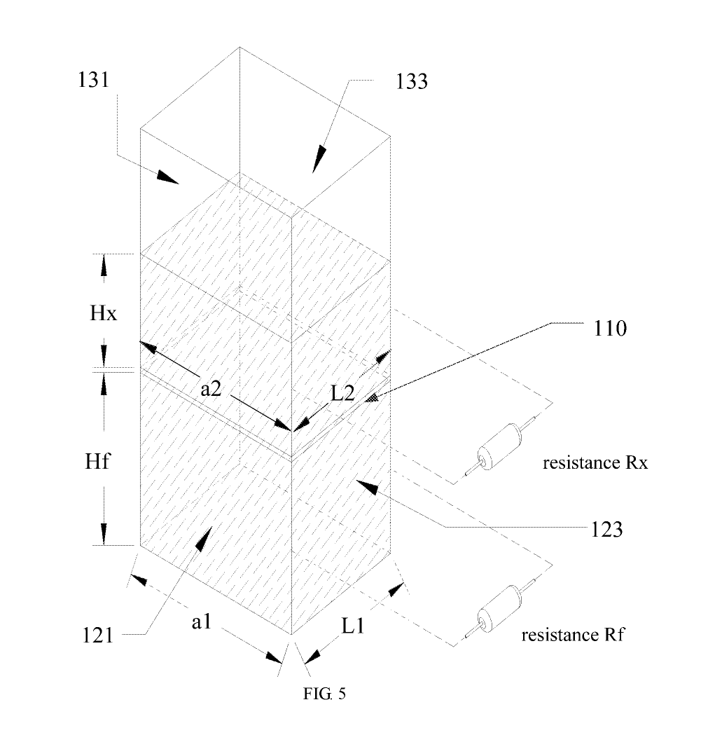

Referring FIG. 5, after the conductive liquid is injected into the container 10, so as to enable the conductive liquid fill the first containing chamber 101 and the locate in the second containing chamber 103. The height Hf that from the partition plate 110 to the bottom of the container 10 is a known parameter. Providing that Rf represents internal resistance between the first electrode plate 121 and the second electrode plate 123, thus the height of the conductive liquid in the first containing chamber 101 can be expressed as:

Hf=ρL1/(a1×Rf) Eq. (1-3)

In the equation, L1 represents an interval between the first electrode plate 121 and the second electrode plate 123, a1 represents a width of the first electrode plate 121. i.e., the first electrode pair 120 is equivalent to a reference electrode pair, and the first containing chamber 101 is equivalent to a reference water tank. The height Hf of the conductive liquid in the first containing chamber 101 equals to the height Hf from the partition plate 110 to the bottom of the container 10 or the height of the first electrode pair 120.

Similarly, providing that Rx represents internal resistance between the third electrode plate 131 and the fourth electrode plate 133, thus the height of the conductive liquid located in the second containing chamber 103 can be expressed as:

Hx=ρL2/(a2×Rx) Eq. (1-4)

In the equation, L2 represents an interval between the third electrode plate 131 and the fourth electrode plate 133; a2 represents a width of third electrode plate 131. The interval L1 between the first electrode plate 121 and the second electrode plate 123 equals to the interval L2 between the third electrode plate 131 and the fourth electrode plate 133, i.e., L1=L2. The widths of the first electrode plate 121, the second electrode plate 123, the third electrode plate 131, and the fourth electrode plate 133 are the same, i.e., a1=a2. The following relationship can be acquired with Eq. (1-4) divided by Eq. (1-3):

Hx=Hf×Rf/Rx Eq. (1-5)

In one embodiment, the width of the first electrode plate 121 is the same as the width of the third electrode plate 131, and the width of the second electrode plate 123 is the same as the width of the fourth electrode plate 133. The width of the first electrode plate 121 and the third electrode plate 131 are narrower than the width of the first inner wall of the container 10. The width of the second electrode plate 123 and the fourth electrode plate 133 can be narrower than the width of the first inner wall of the container 10.

Since the height Hf from the partition plate 110 to the bottom of the container 10 is a known parameter, it is possible to calculate the height Hx of the conductive liquid in the second containing chamber 103 by calculating a resistance ratio Rf/Rx of the first electrode pair 120 and the first electrode pair 120.

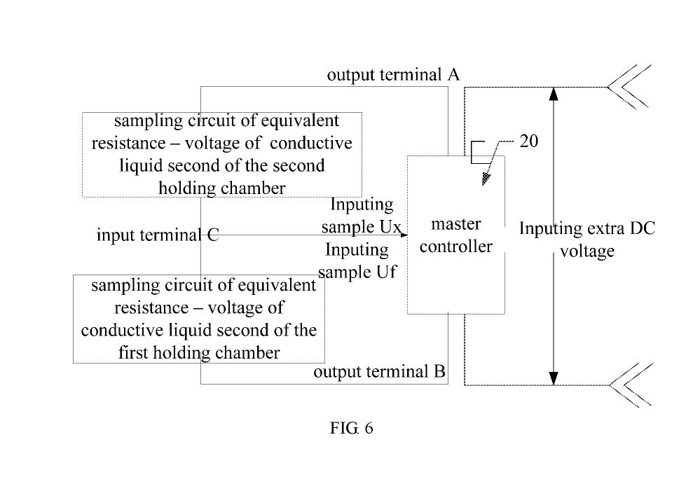

In one embodiment, the master chip 210 is electrically coupled to the first electrode plate 121, the third electrode plate 131, and the fourth electrode plate 133, respectively. The fourth electrode plate 133 is electrically coupled to the second electrode plate 123. The master chip 210 is used to measure a voltage value of the first electrode pair 120 and the second electrode pair 130. Referring to FIG. 6, the master chip 210 connects the first electrode pair 120 and the second electrode pair 130 in series to form a loop. A voltage signal is output at a output terminal A and a output terminal B of the master chip 210, thus forming a voltage drop between the output terminal A and the output terminal B. Voltage values U_{A}, U_{B}, and U_{C} of the output terminal A, the output terminal B, and a input terminal C are collected by the master chip 210, respectively. The voltage Uf across internal resistance Rf of the conductive liquid in the first containing chamber 101 can be expressed as Uf=U_{C}−U_{B}. The voltage Ux across internal resistance Rx of the conductive liquid in the second containing chamber 103 can be expressed as Ux=U_{A}−U_{C}. Internal resistance Rf and Rx are connected in series in the loop, the following equation can be acquired:

Uf/Ux=Rf/Rx Eq. (1-6)

Substituting Eq. (1-6) into Eq. (1-5), Eq. (1-7) can be obtained as follows:

Hx=Hf×Uf/Ux=Uf×[(UC−UB)/(UA−UC)]) Eq. (1-7)

The height Hx of the conductive liquid in the second containing chamber 103 can be calculated according to Eq. (1-6), and a total height h of the conductive liquid in the container 10 , i.e., h=Hf+Hx.

Furthermore, a volume V of the conductive liquid in the container 10 can be calculated according to the bottom area s of the container 10, i.e., V=s×h. The volume of the container 10 can be efficiently and accurately detected by the foregoing apparatus.

In one embodiment, when the outlet 140 of bottom of the container is opened and the master chip 210 has detected a variation of a voltage value of the second electrode pair, the master chip 210 thereof controls the timing unit 220 to start timing until that the master chip 210 detects that a voltage value of the second electrode pair has not varied, stopping timing. The feedback of the recorded length T of time is made to the master chip 210 by the timing unit 220.

In one embodiment, the apparatus further includes a switch module (not shown), which is used to control the opening or closing of the outlet 140. The switch module is connected to the master chip 210, and the master chip 210 controls the opening or closing of the switch module. When the switch module is opened, the timing unit 220 of the master chip 210 starts timing. When the switch module is closed, the timer unit 220 stops timing and sends the length T of the recorded time to the master chip 210 to process.

In one embodiment, the master chip 210 calculates the first height Hx of the conductive liquid in the second containing chamber 103 before the outlet 140 is opened. When the outlet 140 is closed, the master chip 210 calculates the second height Hx′ of the conductive liquid in the second containing chamber 103. Then calculating a volume V of the conductor capacity flowing out of the outlet 140 according to the contact area s of the container and the conductive liquid. The volume V=s×(Hx−Hx′). Then, the timing unit 220 sends the length T of the recorded time to the master chip 210 to calculate the flow rate Q=V/T at the outlet 140.

In one embodiment, the master chip 210 calculates a volume V1=s×Hx of the conductive liquid in second containing chamber 103 according to the contact area s of the container and the conductive liquid, and the first height Hx of the conductive liquid in the second containing chamber 103 before the outlet 140 is opened. When the outlet 140 is closed, the master chip 210 calculates a volume V2=s×Hx′ of the conductive liquid in the second containing chamber 103 according to the contact area s of the container and the conductive liquid, and the second height Hx′ of the conductive liquid in the second containing chamber 103. Then, the timing unit 220 sends the length T of the recorded time to the master chip 210 to calculate the flow rate Q=V/T at the outlet 140.

The flow rate at the outlet 140 can be calculated by the foregoing liquid level detecting apparatus for an arbitrary period of time, which has low cost, high measuring accuracy and high efficiency.

The first electrode plate 121 and the third electrode plate 131 are insulated by the partition plate 110, and the second electrode plate 123 and the fourth electrode plate 133 are insulated by the partition plate 110. The partition plate 110 is an insulating partition plate 110 for separating the first containing chamber 101 from the second containing chamber 103. In one embodiment, a through hole 111 is arranged on the partition plate 110, thus it is convenient for the conductive liquid in the second containing chamber 103 to flow into the first containing chamber 101. Since a small size of the through hole 111, the influence of measuring the voltage value of the first electrode pair 120 and the second electrode pair 130 can be negligible.

In one embodiment, the first containing chamber 101 defines a first directing port (not shown) on a side wall thereof. The second containing chamber 103 defines a second directing port (not shown) on a side wall thereof. The first directing port and the second directing port are connected by a tube, which enables to direct the conductive liquid in the second containing chamber 103 to the first containing chamber 101 and fill the first containing chamber 101.

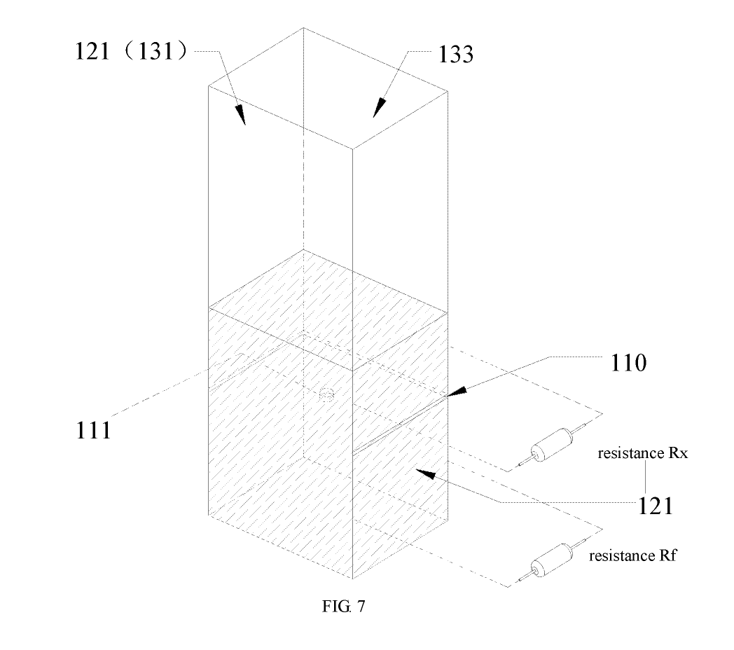

In one embodiment, referring to FIG. 7, the first electrode plate 121 and the third electrode plate 131 are integrally formed, and the second electrode plate 123 and the fourth electrode plate 133 are insulated via the partition plate 110.

In one embodiment, the first electrode plate 121 and the third electrode plate 131 are insulated via the partition plate 110, and the second electrode plate 123 and the fourth electrode plate 133 are integrally formed.

The first electrode plate 121 and the third electrode plate 131 are integrally formed or the second electrode plate 123 and the fourth electrode plate 133 are integrally formed, so as to reduce the connection line, optimize the internal wiring in the foregoing apparatus, and save the cost, as well.

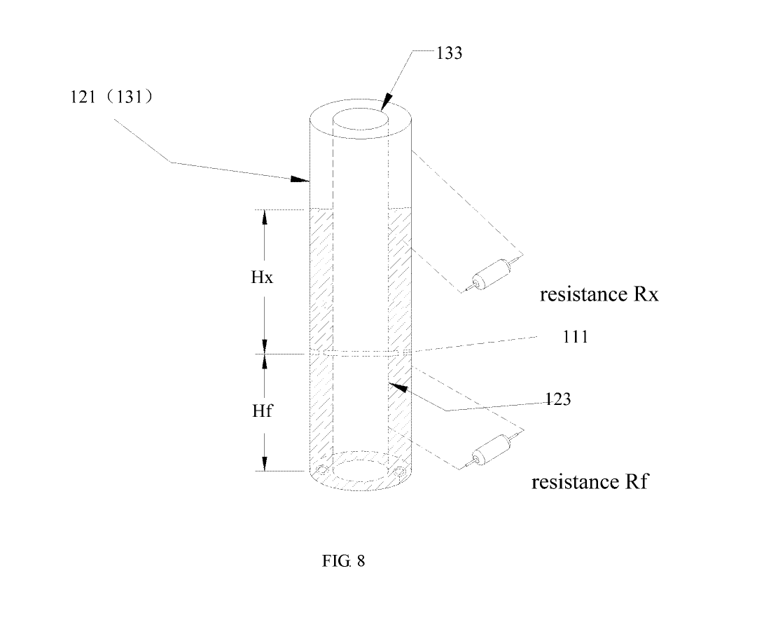

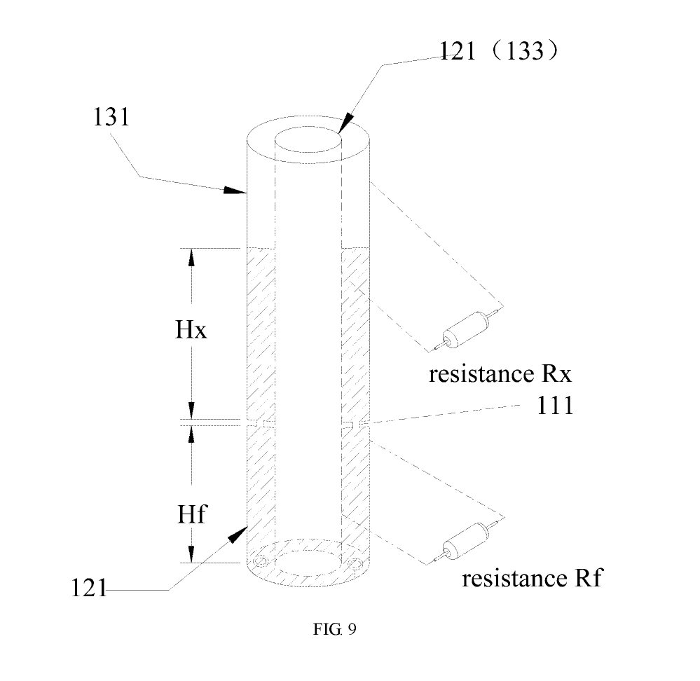

In one embodiment, the container 10 is shaped as annular cylinder, referring to FIGS. 8 and 9, and the conductive liquid is contained in an empty chamber of the annular cylinder. The first electrode plate 121, the second electrode plate 123, the third electrode plate 131, and the fourth electrode plate 133 are shaped as annulus. The first electrode plate 121 is attached to a first annular wall in contact with the conductive liquid of the container 10, and the second electrode plate 123 is attached to a second annular wall in contact with the conductive liquid of the container 10. The third electrode plate 131 is attached to the first annular wall and extends along an extending direction of the first electrode plate 121, and the fourth electrode plate 133 is attached to the second annular wall and extends along an extending direction of the second electrode plate 123.

With reference to the above principles, the following can be draw:

Hx=Hf×Uf/Ux=Hf×([(UC−UB)/(UA−UC)]).

In the equation, Hx represents the height from the liquid level to the partition plate 110HHH, i.e., a actual height from the partition plate 110 to the bottom of the container 10. The voltage value Uf of the first electrode pair 120 and the voltage value Ux of the second electrode pair 130 can be calculated via the master chip 210. The actual height Hx of the conductive liquid in the second containing chamber 103 can be calculated in the case where the height Hf of the first electrode pair 120, the voltage value Uf of the first electrode pair 120, and the voltage value Ux of the second electrode pair 130 are known.

The height Hx of the conductive liquid in the second containing chamber 103 is calculated, and the total height of the conductive liquid in the container 10 is as follows: h=Hf+Hx.

Furthermore, the volume V of the conductive liquid in the container 10 can be calculated according to the bottom area s of the container 10. The volume in the container 10 can be efficiently and accurately detected by the foregoing apparatus.

In one embodiment, the master chip 210 calculates the first height Hx of the conductive liquid in the second containing chamber 103 before the outlet 140 is opened. When the outlet 140 is closed, the master chip 210 calculates the second height Hx′ of the conductive liquid in the second containing chamber 103. Then calculating the volume V of the conductor capacity flowing out of the outlet 140 according to the contact area s of the container and the conductive liquid. The volume V=s×(Hx−Hx′). Then, the timing unit 220 sends the length T of the recorded time to the master chip 210 to calculate the flow rate Q=V/T at the outlet 140.

In one embodiment, the first electrode plate 121 and the third electrode plate 131 can be integrally formed, and the second electrode plate 123 and the fourth electrode plate 133 are insulated by the partition plate 110. In one embodiment, the first electrode plate 121 and the third electrode plate 131 are insulated by the partition plate 110, and the second electrode plate 123 and the fourth electrode plate 133 are integrally formed. The first plate and the third electrode plate 131 are integrally formed or the second electrode plate 123 and the fourth electrode plate 133 are integrally formed, so as to reduce the connection line, optimize the internal wiring in the foregoing apparatus, and save the cost, as well.

The foregoing liquid level detecting apparatus can be applied to a product in which required to detect the liquid height level, such as a water dispenser, a coffee machine, a soybean milk machine, a blender, an electric water heater, and so on.

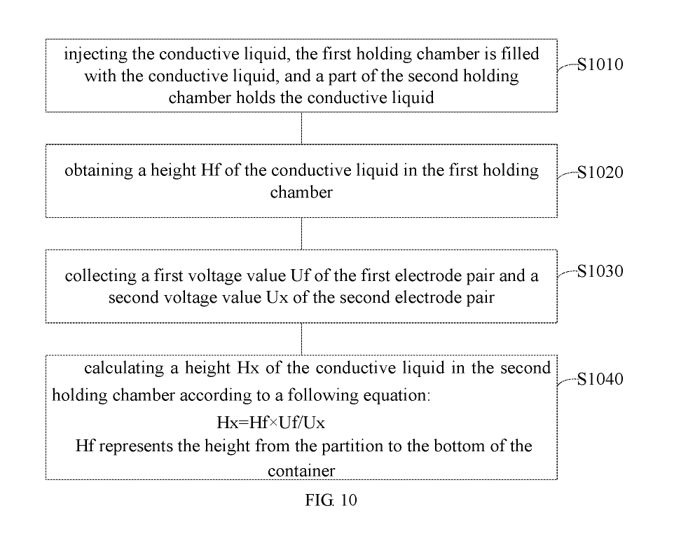

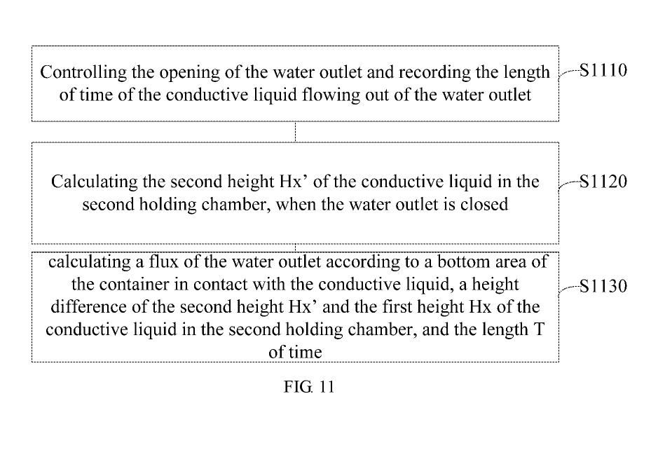

In one embodiment, referring to FIG. 10, a liquid level detecting method based on the liquid level detecting apparatus, the liquid level detecting method includes:

In step S1010: the conductive liquid is injected, the first containing chamber is full of the conductive liquid, and the second holding chamber is partially filled with the conductive liquid.

The partition plate 110, the first electrode pair 120 and the second electrode pair 120 are arranged on the related positions of the container 10. A liquid level line of the conductive liquid is located in the second containing chamber 103, i.e., the conductive liquid can fill the first containing chamber 101 and flow over the partition plate 110, thus a portion of the conductive liquid is contained in the second containing chamber 103.

In step S1020: the height Hf of the conductive liquid in the first containing chamber 101 is obtained.

The height Hf of the conductive liquid of the first containing chamber 101 is obtained since the conductive liquid fill the first containing chamber 101, that is, the height of the conductive liquid of the first containing chamber 101 equals to the height from the partition plate 110 to the bottom of the container, i.e., the height of the first electrode pair 120.

In step S1030: the voltage value Uf of the first electrode pair 120 and the voltage value Ux of the second electrode pair 130 is collected.

The first electrode pair 120 includes a first electrode plate 121 and a second electrode plate 123, which has the same height. The second electrode pair 130 includes a third electrode plate 131 and a fourth electrode plate 133, which has the same height. The third electrode plate 131 extends along an extension direction of the first electrode plate 121, and the fourth electrode plate 133 extends along an extension direction of the second electrode plate 123. The fourth electrode plate 133 is electrically coupled to the second electrode plate 123.

The master chip 210 connects the first electrode pair 120 and the second electrode pair 130 in series to form a loop. A voltage signal is output at a output terminal A and a output terminal B, thus forming a voltage drop between the output terminal A and the output terminal B. Voltage values UA, UB, and UC of the output terminal A, the output terminal B, and a input terminal C are collected by the master chip 210, respectively. Collecting the first voltage value Uf of the first electrode pair 120, i.e., the voltage Uf=UC−UB across internal resistance Rf of the conductive liquid in the first containing chamber 101. Collecting the second voltage value Ux of the second electrode pair 130, i.e., the voltage Ux=UA−UC across internal resistance Rx of the conductive liquid in the second containing chamber 103.

The step S120 that obtaining the height of the conductive liquid of the first containing chamber 101 can be performed before any step before step S140.

In step S1040: the height Hx of the conductive liquid in the second containing chamber 103 is calculated according to the following equation:

Hx=HF×Uf/Ux.

Since internal resistance Rf and Rx are connected in series in the loop, a resistance ratio of internal resistance of the electrode pair 120 and the second electrode pair 130 can be calculated according to the first voltage value Uf and the second voltage value Ux, thus the following can be drawn:

Uf/Ux=Rf/Rx.

That is, the ratio of the first voltage value Uf to the second voltage value Ux equals to the resistance ratio Rf/Rx. Internal resistance Rf is internal resistance of the conductive liquid between the first electrode pairs 120; internal resistance Rx is internal resistance of the conductive liquid between the second electrode pairs 130.

The first electrode pair 120 includes the first electrode plate 121 and the second electrode plate 123.

The first electrode plate 121 and the second electrode plate 123 are arranged in parallel or coaxially. If the container is shaped as a cuboid or a cube, thus the first electrode plate 121 and the second electrode plate 123 are both rectangles and arranged in parallel. If the container is shaped as an annular cylinder, thus the first electrode plate 121 and the second electrode plate 123 are both shaped as annulus and arranged coaxially.

Hence, a method of obtaining internal resistance value Rf of the first electrode pair 120 is described by taking the container as the cuboid as an example.

The first electrode plate 121 has a same structure and size as the second electrode plate 123, and the third electrode plate 131 has a same structure and size as the fourth electrode plate 133. The first electrode plate 121 completely covers the first inner wall of the first containing chamber 101, and the second electrode plate 123 completely covers the second inner wall of the first containing chamber 101. The third electrode plate 131 completely covers the second inner wall of the second containing chamber 103, and the fourth electrode plate 133 completely covers the second inner wall of the second containing chamber 103.

Since the height Hf that from the partition plate 110 to the bottom of the container 10 is a known parameter. Internal resistance Rf between the first electrode plate 121 and the second electrode plate 123 can be expressed as:

Rf=ρL1/(a1×Hf).

In the equation, L1 represents the interval between the first electrode plate 121 and the second electrode plate 123, a1 represents the width of the first electrode plate 121, i.e., the first electrode pair 120 is equivalent to the reference electrode pair, and the first containing chamber 101 is equivalent to the reference water tank. The height Hf of the conductive liquid in the first containing chamber 101 equals to the height Hf from the partition plate 110 to the bottom of the container 10 or the height of the first electrode pair 120.

Providing that Hx represents the height of the conductive liquid located in the second containing chamber 103, thus internal resistance Rx between the third electrode plate 131 and the fourth electrode plate 133 can be expressed as:

Rx=ρL2/(a2×Hx)

In the equation, L2 represents the interval between the third electrode plate 131 and the fourth electrode plate 133; a2 represents the width of third electrode plate 131. The interval L1 between the first electrode plate 121 and the second electrode plate 123 equals to the interval L2 between the third electrode plate 131 and the fourth electrode plate 133, i.e., L1=L2. The widths of the first electrode plate 121, the second electrode plate 123, the third electrode plate 131, and the fourth electrode plate 133 are the same, i.e., a1=a2. The following can be drawn according to the forgoing equation:

Hx=Hf×Rf/Rx

Thus the height Hx of the conductive liquid in the second containing chamber can be calculated.

In one embodiment, the method further includes a step of that calculating the volume V of the conductive liquid according to the conductive liquid height Hf of the first containing chamber 101, the conductive liquid height Hx of the second containing chamber 103, and the contact area s between the bottom of the container 10 and the conductive liquid.

Since the conductive liquid height Hf of the first containing chamber 101 and the conductive liquid height Hx of the second containing chamber 103 are obtained, the volume V1=s×Hf of the first containing chamber 101 and the volume V2=s×Hx of the second containing chamber 103 can be respectively calculated according to the contact area s between the bottom of the container 10 and the conductive liquid. The total height h=Hf+Hx of the conductive liquid can also be calculated. Furthermore, the volume V=s×h or V=s×Hf+s×Hx of the conductive liquid in the container 10 can be calculated.

In one embodiment, the container 10 defines an outlet 140 on the bottom thereof. The method further includes:

In step S1110, the opening of the outlet 140 is controlled, and the length T of time of the conductive liquid flowing out the outlet is recorded.

when the outlet 140 of bottom of the container is opened and the master chip 210 has detected a variation of a voltage value of the second electrode pair, the master chip 210 thereof controls the timing unit 220 to start timing until that the master chip 210 detects that a voltage value of the second electrode pair has not varied, stopping timing. The feedback of the recorded length T of time is made to the master chip 210 by the timing unit 220. At the same time, the master chip 210 calculates a first height Hx of the conductive liquid in the second containing chamber 103 before the outlet 140 is opened.

In step S1120: a second height of the conductive liquid in the second containing chamber 103 is calculated when the outlet 140 is closed.

When the outlet 140 is closed, the master chip 210 calculates the second height Hx′ of the conductive liquid in the second containing chamber 103.

In step S1130: a flow rate at the outlet is calculated according to a bottom area of the container which is in contact with the conductive liquid, a height difference of the second height Hx′ and the first height Hx of the conductive liquid in the second containing chamber, and the length T of time.

In one embodiment, a volume V of the conductor capacity flowing out of the outlet 140 is calculated according to the contact area s of the container 10 and the conductive liquid, where the volume V=s×(Hx−Hx′). Then, the feedback of the recorded length T of time is made to the master chip 210 by the timing unit 220, and the flow rate Q=V/T at the outlet 140 is calculated by the master chip 210.

The flow rate at the outlet 140 can be calculated by the foregoing liquid level detecting method for an arbitrary period of time, which has low cost, high measuring accuracy and high efficiency.

The foregoing liquid level detecting method can be applied to a product in which required to detect the liquid height level, such as a water dispenser, a coffee machine, a soybean milk machine, a blender, an electric water heater, and so on.

The technical features of the embodiments described above can be arbitrarily combined. In order to make the description succinct, there is no describing of all possible combinations of the various technical features in the foregoing embodiments. It should be noted that there is no contradiction in the combination of these technical features which should be considered as the scope of the description.

The foregoing implementations are merely specific embodiments of the present disclosure, but are not intended to limit the protection scope of the present disclosure. It should be noted that any variation or replacement readily figured out by persons skilled in the art within the technical scope disclosed in the present disclosure shall all fall within the protection scope of the present disclosure. Therefore, the protection scope of the present disclosure shall be subject to the protection scope of the claims.

What is claimed is:

1. A liquid level detecting apparatus comprising:
a container configured to contain conductive liquid;
a partition plate dividing the container into a first containing chamber and a second containing chamber, wherein the first containing chamber is located on a bottom of the container, and the second containing chamber is located on a top of the container; the first containing chamber is full of the conductive liquid, and the second containing chamber is partially filled with the conductive liquid;
a first electrode pair vertically arranged in the first containing chamber, wherein the first electrode pair is in contact with the bottom of the container and extends to the partition plate;
a second electrode pair vertically arranged in the second containing chamber and abutting against the partition plate, wherein the second electrode pair extends along an extending direction of the first electrode pair and extends to the top of the container, and the second electrode pair is electrically coupled to the first electrode pair; and
a master chip electrically coupled to the first electrode pair and the second electrode pair, respectively; wherein the master chip is configured to measure a first voltage value Uf of the first electrode pair and a second voltage value Ux of the second electrode pair, and the master chip calculates a height Hx of the conductive liquid in the second containing chamber according to a following equation:
Hx=Hf×Uf/Ux
wherein Hf represents a height from the partition plate to the bottom of the container.

2. The liquid level detecting apparatus of claim 1, wherein the first electrode pair comprises a first electrode plate and a second electrode plate, the heights of the first electrode plate and the second electrode plate are the same; the second electrode pair comprises a third electrode plate and a fourth electrode plate, the heights of the third electrode plate and the fourth electrode plate are the same; the third electrode plate extends along an extension direction of the first electrode plate, and the fourth electrode plate extends along an extension direction of the second electrode plate.

3. The liquid level detecting apparatus of claim 2, wherein the container is shaped as a cuboid; the first electrode plate, the second electrode plate, the third electrode plate, and the fourth electrode plate are shaped as rectangles, the width of the first electrode plate is the same as the width of the third electrode plate; the width of the second electrode plate is the same as the width of the fourth electrode plate;
the first electrode plate is attached to a first inner wall of the container, the second electrode plate is arranged in parallel to the first electrode plate and is attached to a second inner wall which is opposite to the first inner wall;
the third electrode plate is attached to the first inner wall and extends along an extension direction of the first electrode plate; the fourth electrode plate is attached to the second inner wall and extends along an extension direction of the second electrode plate.

4. The liquid level detecting apparatus of claim 2, wherein the container is shaped as an annular cylinder, and the conductive liquid is contained in an empty chamber of the annular cylinder; the first electrode plate, the second electrode plate, the third electrode plate, and the fourth electrode plate are shaped as rings;
the first electrode plate is attached to a first annular wall of the container which is in contact with the conductive liquid, and the second electrode plate is attached to a second annular wall of the container which is in contact with the conductive liquid;
the third electrode plate is attached to the first annular wall and extends along an extension direction of the first electrode plate, and the fourth electrode plate is attached to the second annular wall and extends along an extension direction of the second electrode plate.

5. The liquid level detecting apparatus of claim 2, wherein the master chip is electrically coupled to the first electrode plate, the third electrode plate, and the fourth electrode plate, respectively; the fourth electrode plate is electrically coupled to the second electrode plate; the master chip is configured to measure a voltage value of the first electrode pair and a voltage value of the second electrode pair, and to calculate the resistance ratio according to the voltage value of the first electrode pair and the voltage value of the second electrode pair.

6. The liquid level detecting apparatus of claim 2, wherein the first electrode plate and the third electrode plate are insulated via the partition plate, and the second electrode plate and the fourth electrode plate are insulated via the partition plate.

7. The liquid level detecting apparatus of claim 2, wherein the first electrode plate and the third electrode plate are integrally formed, and the second electrode plate and the fourth electrode plate are insulated via the partition plate; or the first electrode plate and the third electrode plate are insulated via the partition plate, and the second electrode plate and the fourth electrode plate are integrally formed.

8. The liquid level detecting apparatus of claim 1, wherein the container defines an outlet on the bottom thereof; and the conductive liquid flows out through the outlet to vary the liquid level.

9. The liquid level detecting apparatus of claim 8, further comprising a timing unit electronically coupled to the master chip, wherein the timing unit is configured to record a length of time before and after continuous variation of the height of the conductive liquid in the second containing chamber; the master chip is further configured to calculate a flow rate at the outlet according to an contact area between the bottom of the container and the conductive liquid, a height difference before and after continuous variation of the conductive liquid in the second containing chamber, and the length of time.

10. The liquid level detecting apparatus of claim 1, wherein the container is provided with a liquid guiding means configured to guide the conductive liquid in the second containing chamber to the first containing chamber and fully fill the first containing chamber.

11. The liquid level detecting apparatus of claim 10, wherein the liquid guiding means is a through hole defined on the partition plate.

12. A liquid level detecting method based on a liquid level detecting apparatus, the liquid level detecting apparatus comprising a container, a partition plate, a first electrode pair, a second electrode pair, and a master chip, wherein the partition plate, the first electrode pair, and the second electrode pair are arranged in the container; wherein the partition plate divides the container into a first containing chamber and a second containing, the first containing chamber is located on a bottom of the container, and the second containing chamber is located on a top of the container; the first electrode pair is vertically arranged in the first containing chamber, the second electrode pair is vertically arranged in the second containing chamber; the master chip is electrically coupled to the first electrode pair and the second electrode pair, respectively, and the second electrode pair is electrically coupled to the first electrode pair; the method comprises:
injecting the conductive liquid, wherein the first containing chamber is full of the conductive liquid, and the second holding chamber is partially filled with the conductive liquid;
obtaining a height Hf of the conductive liquid in the first containing chamber;
collecting a first voltage value Uf of the first electrode pair and a second voltage value Ux of the second electrode pair;
calculating a height Hx of the conductive liquid in the second containing chamber according to a following equation:
Hx=Hf×Uf/Ux
wherein Hf represents the height from the partition plate to the bottom of the container.

13. The method of claim 12, further comprising: calculating a volume of the conductive liquid according to the height of the conductive liquid in the first containing chamber and the second containing chamber, and a contact area between the bottom of the container and the conductive liquid.

14. The method of claim 12, wherein the container defines an outlet on a bottom thereof, the method further comprises:
controlling the outlet to open and recording a length of time of the conductive liquid flowing out of the outlet;
calculating a second height in the conductive liquid of the second containing chamber when the outlet is closed; and
calculating a flow rate at the outlet according to a bottom area of the container contacting the conductive liquid, a height difference of a first height and the second height in the second containing chamber, and the length of time.
